(19) United States
(12) Patent Application Publication
(10) Pub. No.: US 2017/0055534 A1
(43) Pub. Date: Mar. 2, 2017

(54) PROCESS FOR TREATING PLANTS TO CONTROL BACTERIAL AND FUNGAL GROWTH

(71) Applicant: Phyton Corporation, Bloomington, MN (US)

(72) Inventors: William D. Gullickson, JR., Bloomington, MN (US); Patrick McGinnity, Ham Lake, MN (US)

(21) Appl. No.: 14/834,623

(22) Filed: Aug. 25, 2015

(51) Int. Cl. A01N 59/20; A01N 59/16; A01N 43/16; A01G 1/00

(52) U.S. Cl. CPC A01N 59/20; A01G 1/001; A01N 59/16; A01N 43/16

(57) ABSTRACT

A process for controlling bacterial and fungal growth in a plant that includes (a) applying to a surface of a plant an aqueous composition that include a copper compound, a zinc compound, and a manganese compounds; and (b) allowing the composition to dry to form a treated plant. The treated plant displays increased resistance to bacterial and fungal growth relative to an untreated plant.

### TECHNICAL FIELD

This invention relates to treating plants to control bacterial and fungal growth.

### BACKGROUND

Pathogenic bacteria and fungi are known to infect and damage a number of plants. For example, oak wilt disease and Dutch elm disease are caused by different species of the fungus Ceratocystis. Bacterial species known to infect plants include species of the genus Xanthomonas, Pseudomonas, Erwinia, and Corynebacterium. Copper-based compositions have been used effectively to protect plants from bacteria and fungi. However, such compositions are not effective against copper-resistant bacteria and fungi that have now developed.

### SUMMARY

A process for controlling bacterial and fungal growth in a plant is described that includes (a) applying to a surface of a plant an aqueous composition that include a copper compound, a zinc compound, and a manganese compound; and (b) allowing the composition to dry to form a treated plant. The treated plant displays increased resistance to bacterial and fungal growth relative to an untreated plant.

As used herein, the term “compound” includes hydrates. The term “plant” includes seeds.

Examples of suitable copper compounds include water-soluble copper compounds selected from the group consisting of copper sulfate, copper chlorate, copper nitrate, copper chloride, and combinations thereof The amount of copper metal in the composition is between 1 and 5% by weight based upon the weight of the composition.

Examples of suitable zinc compounds include water-soluble zinc compounds selected from the group consisting of zinc sulfate, zinc chlorate, zinc nitrate, zinc chloride, and combinations thereof The amount of zinc metal in the composition is between 1 and 5% by weight based upon the weight of the composition.

Examples of suitable manganese compounds include water-soluble manganese compounds selected from the group consisting of manganese sulfate, manganese chlorate, manganese nitrate, manganese chloride, and combinations thereof The amount of manganese metal in the composition is between 0.1 and 0.5% by weight based upon the weight of the composition.

The composition may also include a nickel compound. Examples of suitable nickel compounds include water-soluble nickel compounds selected from the group consisting of nickel sulfate, nickel chlorate, nickel nitrate, nickel chloride, and combinations thereof The amount of nickel metal in the composition is between 0.1 and 0.5% by weight based upon the weight of the composition.

The composition may also include tannic acid.

Plants treated with the composition exhibit increased resistance to bacterial and fungal growth related to untreated plants. Moreover, including zinc and manganese in combination with copper enables the compositions to treat copper-resistant fungi and bacteria. At the same time, the composition is non-phytotoxic.

The details of one or more embodiments of the invention are set forth in the accompanying drawings and the description below. Other features, objects, and advantages of the invention will be apparent from the description and drawings, and from the claims.

### DETAILED DESCRIPTION

The fungicidal/bactericidal aqueous compositions include a copper compound, a zinc compound, and a manganese compound. The compositions are effective against a variety of fungi and bacteria. In particular, the inclusion of zinc and manganese renders the compositions effective against copper-resistant fungi and bacteria such as Xanthomonas campestris and Pseudomonas syringae. Examples of suitable copper, zinc, and manganese compounds, as well as their relative amounts, are described in the Summary of the Invention, above. The compositions may also include a nickel compound as a stabilizer. Examples of suitable nickel compounds, and their relative amounts, are described in the Summary of the Invention, above. Other ingredients may be included as well. Examples of suitable additional ingredients include tannic acid, surfactants (e.g., sodium lauryl sulfate), pigments (e.g., SMC white, which also can function as a solvent/carrier) to facilitate visualization upon application to a plant surface, and ammonium salts (e.g., ammonium formate). If desired, agents to adjust the viscosity and/or adherent properties of the composition may be included. Examples include water-soluble polymers such as polyvinylpyrrolidone, polyoxyethylene, polyvinyl alcohol, and poyacrylamide.

The compositions are prepared by combining the ingredients in an aqueous carrier. The resulting compositions can be applied directly. Alternatively, the compositions can be dried to form a powder and then reconstituted for use at the appropriate time. The compositions may be applied to a plant surface using conventional techniques such as spraying, painting, or dipping. The compositions may be applied to surfaces such as foliage or to seeds, which are then planted in a conventional manner.

The compositions are useful for treating a variety of plants. Examples include citrus plants (e.g., grapefruit, lemon, lime, orange, tangelo, and tangerine); field crops (e.g, alfalfa, oats, peanuts, potatoes, sugar beets, wheat, and barley); small fruits (e.g., blackberry, cranberry, currant, gooseberry, raspberry, and strawberry); tree crops (e.g., almond, apple, apricot, avocado, banana, cacao, cherry, coffee, filberts, mango, nectarine, olive, peach, pear, pecan, plum, prune, and walnut); vegetables (e.g., beans, broccoli, brussel sprout, cabbage, cantaloupe, carrot, cauliflower, celery, collars, cucumber, eggplant, honeydew, muskmelon, onions, peas, peppers, pumpkin, squash, tomato, and watermelon); vines (e.g, grapes, hops, and kiwi). Additional examples include ginseng, live oak and sycamore and ornamentals (e.g., aralia, azalea, and begonia, bulbs (e.g, Easter lily, tulip, and gladiolus), carnation, chrysanthemum, cotoneaster, euonymus, India hawthorn, ivy, pachysandra, periwinkle, philodendron, pyracantha, rose, and yucca.

### Examples

Tomato plants approximately three weeks old were sprayed until runoff with the compositions set forth in Examples 1-3, below, at 25% label rate to evaluate efficacy of each composition against P.syringae JL-71 bacteria. The compositions were allowed to dry for 24 hours following applications. Bacteria were transferred to new plates approximately one week prior to inoculations to ensure fresh bacterial cultures. Five mL of sterile water was added to each bacteria plate and a flamed spreader was used to suspend cultures in added water. Suspended cultures were then collected, optical density at 600 nm was measured, and cultures were adjusted to OD₆₀₀=0.01. Each fully developed true leaf on the tomatoes was injured at six spots/leaf using a thin metal probe to allow for an infection point. Tomatoes were sprayed with bacteria solutions until runoff. Plants were kept under domes to keep humidity high for three days following inoculation. One week after inoculations disease and vigor ratings were taken. Disease and vigor ratings were averaged for each treatment and standard error was calculated. In each case, the compositions inhibited bacterial growth without harming the plant.

### Example 1

A fungicidal/bactericidal aqueous composition was prepared by combining combining the ingredients in the amounts listed below:

| Ingredients | Sample (g) | Wt. % | Metal % |
|---|---|---|---|
| DI Water | 76.96 | 15.393 | None |
| Tannic Acid, | 5.42 | 1.084 | None |
| Powder, Technical | | | |
| Grade | | | |
| Ammonium | 108.43 | 21.686 | None |
| Formate (Purity >97%) | | | |
| Cupric Sulfate | 31.20 | 6.241 | 1.581 |
| Pentahydrate | | | |
| Zinc Sulfate | 44.17 | 8.834 | 3.136 |
| Monohydrate | | | |
| Nickel Sulfate | 8.86 | 1.771 | 0.392 |
| Hexahydrate | | | |
| Manganese Sulfate | 6.09 | 1.218 | 0.392 |
| Monohydrate | | | |
| Stedapol WAQ-LC | 10.79 | 2.159 | None |
| (Sodium Lauryl | | | |
| Sulfate) | | | |
| SMC White | 208.07 | 41.614 | None |
| (Pigment) | | | |
| TOTAL | 500.00 | 100.000 | 5.501 |

### Example 2

A fungicidal/bactericidal aqueous composition was prepared by combining combining the ingredients in the amounts listed below:

| Ingredients | Sample (g) | Wt. % | Metal % |
|---|---|---|---|
| DI Water | 74.75 | 14.950 | None |
| Tannic Acid, | 5.42 | 1.084 | None |
| Powder, Technical | | | |
| Grade | | | |
| Ammonium | 108.43 | 21.686 | None |
| Formate (Purity >97%) | | | |
| Cupric Sulfate | 38.94 | 7.788 | 1.973 |
| Pentahydrate | | | |
| Zinc Sulfate | 38.65 | 7.730 | 2.744 |
| Monohydrate | | | |
| Nickel Sulfate | 8.86 | 1.771 | 0.392 |
| Hexahydrate | | | |
| Manganese Sulfate | 6.09 | 1.218 | 0.392 |
| Monohydrate | | | |
| Stedapol WAQ-LC | 10.79 | 2.159 | None |
| (Sodium Lauryl | | | |
| Sulfate) | | | |
| SMC White | 208.07 | 41.614 | None |
| (Pigment) | | | |
| TOTAL | 500.00 | 100.000 | 5.501 |

### Example 3

A fungicidal/bactericidal aqueous composition was prepared by combining combining the ingredients in the amounts listed below:

| Ingredients | Sample (g) | Wt. % | Metal % |
|---|---|---|---|
| DI Water | 64.35 | 12.870 | None |
| Tannic Acid, | 5.42 | 1.084 | None |
| Powder, Technical | | | |
| Grade | | | |
| Ammonium | 108.43 | 21.686 | None |
| Formate (Purity >97%) | | | |
| Cupric Sulfate | 85.91 | 17.183 | 4.354 |
| Pentahydrate | | | |
| Zinc Sulfate | 15.33 | 3.066 | 1.088 |
| Monohydrate | | | |
| Manganese Sulfate | 1.69 | 0.338 | 0.109 |
| Monohydrate | | | |
| Stedapol WAQ-LC | 10.79 | 2.159 | None |
| (Sodium Lauryl | | | |
| Sulfate) | | | |
| SMC White | 208.07 | 41.614 | None |
| (Pigment) | | | |
| TOTAL | 500.00 | 100.000 | 5.551 |

A number of embodiments of the invention have been described. Nevertheless, it will be understood that various modifications may be made without departing from the spirit and scope of the invention. Accordingly, other embodiments are within the scope of the following claims.

1. A process for controlling bacterial and fungal growth in a plant comprising:
(a) applying to a surface of the plant an aqueous composition comprising a copper compound in which the amount of copper metal is between 1 and 5% by weight based upon the weight of the composition, (ii) a zinc compound in which the amount of zinc metal is between 1 and 5% by weight based upon the weight of the composition, and (iii) a manganese compound; and
(b) allowing the composition to dry to form a treated plant, wherein the treated plant displays increased resistance to bacterial and fungal growth relative to an untreated plant.

2. The process of claim 1 wherein the aqueous composition further comprises a nickel compound.

3. The process of claim 1 wherein the copper compound is a water-soluble copper compound selected from the group consisting of copper sulfate, copper chlorate, copper nitrate, copper chloride, and combinations thereof.

4. The process of claim 1 wherein the zinc compound is a water-soluble zinc compound selected from the group consisting of zinc sulfate, zinc chlorate, zinc nitrate, zinc chloride, and combinations thereof.

5. The process of claim 1 wherein the manganese compound is a water-soluble manganese compound selected from the group consisting of manganese sulfate, manganese chlorate, manganese nitrate, manganese chloride, and combinations thereof

6. The process of claim 2 wherein the nickel compound is a water-soluble nickel compound selected from the group consisting of nickel sulfate, nickel chlorate, nickel nitrate, nickel chloride, and combinations thereof.

7. The process of claim 1 wherein the aqueous composition further comprises tannic acid.

8. (canceled)

9. (canceled)

10. The process of claim 1 wherein the composition comprises between 0.1 and 0.5% manganese metal by weight based upon the weight of the composition.

11. The process of claim 2 wherein the composition comprises between 0.1 and 0.5% nickel metal by weight based upon the weight of the composition.

12. A process for controlling bacterial and fungal growth in a plant comprising:
(a) applying to a surface of the plant an aqueous composition comprising:
(i) a water-soluble copper compound selected from the group consisting of copper sulfate, copper chlorate, copper nitrate, copper chloride, and combinations thereof, wherein the amount of copper metal is between 1 and 5% by weight based upon the weight of the composition,
(ii) a water-soluble zinc compound selected from the group consisting of zinc sulfate, zinc chlorate, zinc nitrate, zinc chloride, and combinations thereof, wherein the amount of zinc metal is between 1 and 5% by weight based upon the weight of the composition, and
(iii) a water-soluble manganese compound selected from the group consisting of manganese sulfate, manganese chlorate, manganese nitrate, manganese chloride, and combinations thereof, wherein the amount of manganese metal is between 0.1 and 0.5% by weight based upon the weight of the composition; and
(b) allowing the composition to dry to form a treated plant, wherein the treated plant displays increased resistance to bacterial and fungal growth relative to an untreated plant.

13. The process of claim 12 further comprising a water-soluble nickel compound selected from the group consisting of nickel sulfate, nickel chlorate, nickel nitrate, nickel chloride, and combinations thereof, wherein the amount of nickel metal is between 0.1 and 0.5% by weight based upon the weight of the composition.

14. The process of claim 12 wherein the copper compound is copper sulfate, the zinc compound is zinc sulfate, and the manganese compound is manganese sulfate.

15. The process of claim 11 wherein the composition further comprises tannic acid.
